(19) United States
(12) Patent Application Publication
(10) Pub. No.: US 2007/0220574 A1
(43) Pub. Date: Sep. 20, 2007

(54) Method and Apparatus for the Transmission of Dvb Services Over an Ip Network

(76) Inventors: Ralf Schaefer, Acigne (FR); Yves Maetz, Melesse (FR); Jean-Luc Philouze, Bruz (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/574,328

(22) PCT Filed: Sep. 27, 2004
(86) PCT No.: PCT/FR04/50463

§ 371 Date: Dec. 8, 2006

(30) Foreign Application Priority Data
Oct. 7, 2003 (FR) 0311706

(51) Int. Cl. H04N 7/173

(52) U.S. Cl. 725/118

(57) ABSTRACT

Within the framework of the transmission of DVB services over an IP network, the tendency is to separate the signalling information describing the network and the services offered from the services themselves. The signalling is made available to the terminals via XML files available on HTTP servers. In contradistinction to this approach, the invention consists of a method of discovery, by a terminal connected to an IP type network, of DVB services on the IP type network, where the terminal uses a first IP address and a first port number to receive a transport stream transmitted to this IP address on this port. The terminal extracts from the said stream the signalling tables including the networks information table (NIT). The descriptors of networks contained in the said networks information table (NIT) designating IP transmission addresses and the associated ports, the terminal connects to at least part of the transport streams transmitted to the said IP addresses on the said ports so as to read the associated service description table (SDT). The terminal uses this information to construct a possibly unitary list of the services available on the network.

The present invention relates to the transmission of DVB services (Digital Video Broadcasting), DVB defining a service as “a sequence of programs under the control of an operator that can be transmitted within the framework of a programming”, over an IP type network (supporting the IP protocol, Internet Protocol, the specification of which may be found in the RFCs “Request for Comments” maintained by the IETF “Internet Engineering Task Force” under the number 791) and more particularly the discovery by a terminal of the services offered on the network.

The discovery of the DVB services offered by a network is standardized within the framework of a network of satellite, cable or digital terrestrial transmission type. This standard is described in the document “Digital Video Broadcasting (DVB); Specification for Service Information (SI) in DVB Systems” published by the ETSI (European Telecommunication Standard Institute) under the number ETSI EN 300 468. This document describes a set of tables containing information about the network, about the frequencies at which the data streams containing the services are transmitted, about the services on offer etc. These tables are multiplexed in the data streams, the terminal being configured with the data necessary for connecting to a first stream allowing it to receive these tables and to construct, in accordance with their content, a database containing the description of the services offered by the network and the connection data necessary for their reception.

The development of the Internet network, and especially the generalization of high-throughput access, now offer the technical possibility of transmitting audio and video services on this network. Moreover, private networks of high throughput IP type are developing, be it within companies or within the domestic framework. Within this framework DVB is working at the standardization of the transmission of DVB services over IP type networks. A working group called the DVB-IPI (Internet Protocol Infrastructure) is currently finalizing a specification relating to the transport of DVB services over an IP type network, and more particularly the discovery of the services. The proposal as envisaged today is presented in the document “Service Discovery & Service Selection Specification; Part 1—MPEG-2 DVB-IP Services” under the reference IPI2001-059. The solution, as envisaged currently by the working group, is geared towards separation between the transmission of the services in the form of transport streams containing a single DVB service on the one hand and the information describing these services, available in the form of XML files (eXtensible Markup Language) accessible for terminals on request. The HTTP protocol (Hyper Text Transport Protocol) can, for example, be used to retrieve these files. This solution seems natural since it profits from the bidirectional nature of the IP connection in contradistinction to transmission by satellite for example. It in fact makes it possible to save bandwidth by transmitting signalling information only when requested and not permanently in the audio and video channel. Moreover, the making available of information on an IP type network via HTTP servers in the form of XML data files is the dominant solution widely adopted on networks of this type.

However this solution necessitates the development of a set of tools making it possible to generate and to manage the servers offering this signalling information in the XML format. Now, at the present time, content transmitters employ a perfected infrastructure for transmitting DVB MPEG-2 services via satellite or cable. The adoption of this new signalling scheme necessitating the development, in parallel with the existing system, of new tools involves investment and risk taking for the operators. Moreover, today the terminals do not integrate the tools required for the analysis of this information, such as for example, an XML analyser. The integration of such tools into a low-cost terminal may turn out to be tricky or even impossible as a function of the hardware resources available such as the power of the processor or the memory.

The aim of the invention is therefore to offer a method of transmitting DVB services over an IP type network and more particularly the discovery of the services offered on the network by a terminal. This method allowing the maximum reuse of the currently deployed production chain of DVB services for satellite or cable with the aim of transmitting DVB services over an IP type network.

The invention consists of a method of discovery, by a terminal connected to an IP type network, of DVB services on the IP type network, where the terminal uses a first IP transmission address and a first port number to receive a transport stream transmitted to this IP address on this port. The terminal extracts from the said stream the signalling tubes including the networks information table (NIT). The descriptors of networks contained in the said networks information table (NIT) designating IP transmission addresses and the associated ports, the terminal connects to at least part of the transport streams transmitted to the said IP addresses on the said ports so as to read the associated service description table (SDT). The terminal uses this information to construct a possibly unitary list of the services available on the network.

According to a particular embodiment of the invention the first IP transmission address and the first port number are entered by the user.

According to a particular embodiment of the invention the first IP address and the first port number are obtained from the network by the terminal.

According to a particular embodiment of the invention the streams contain only a single DVB service.

According to a particular embodiment of the invention the list of services is included in the NIT contained in the stream available at the first IP transmission address on the first port.

The invention also relates to a device possessing means to connect to an IP transmission address via means of connection to an IP network and means of decoding of DVB streams transmitted to this IP transmission address, characterized in that the means of decoding of DVB streams have the capacity to analyse an NIT, extracted from the stream, containing network descriptors suitable for the IP network and to connect to each IP transmission address described in the said NIT so as to read therefrom a DVB stream and extract therefrom the information on the services offered on the network preferably according to any one of the methods according to the previous claims.

The invention also relates to a descriptor of a service for transmitting a DVB stream intended to be included in an NIT characterized in that it contains the IP transmission address of a stream server and a port number on which the said server transmits a DVB stream over an IP type network.

The invention will be better understood, and other features and advantages will become apparent on reading the description which follows, the description making reference to the appended drawings in which:

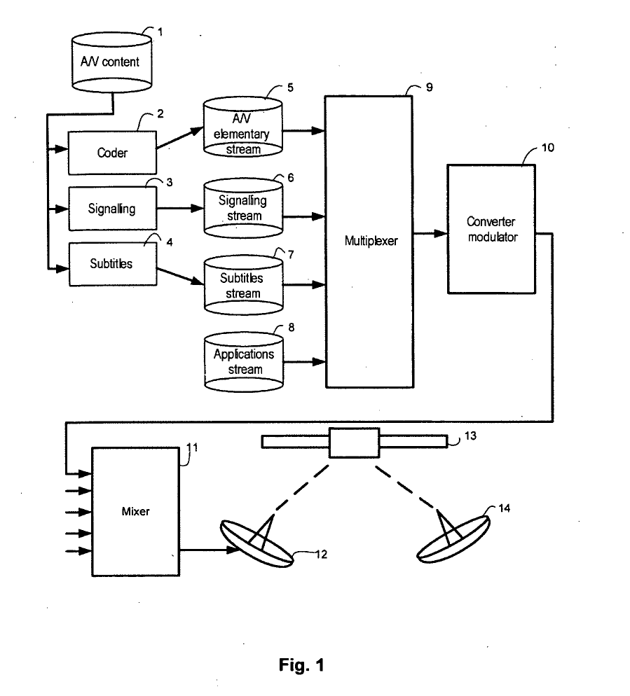

FIG. 1 represents a diagram of the production chain of DVB services within the framework of a conventional satellite transmission.

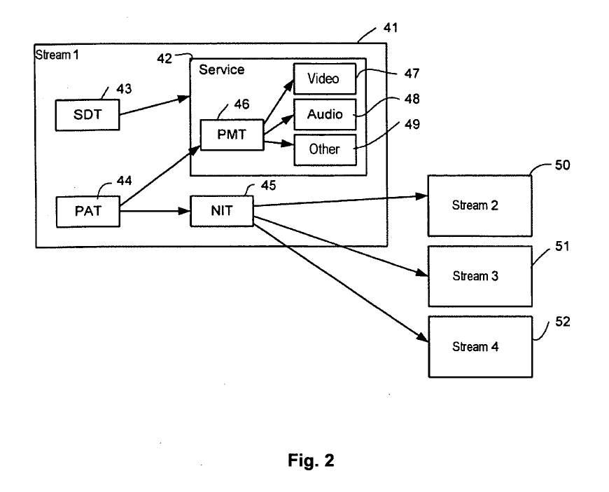

FIG. 2 represents the architecture of a DVB data stream in the framework of the invention.

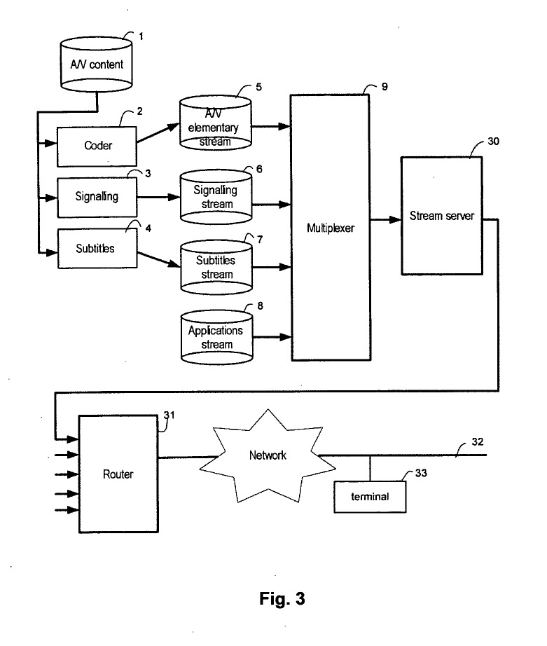

FIG. 3 represents a diagram of an exemplary production chain modified according to the invention.

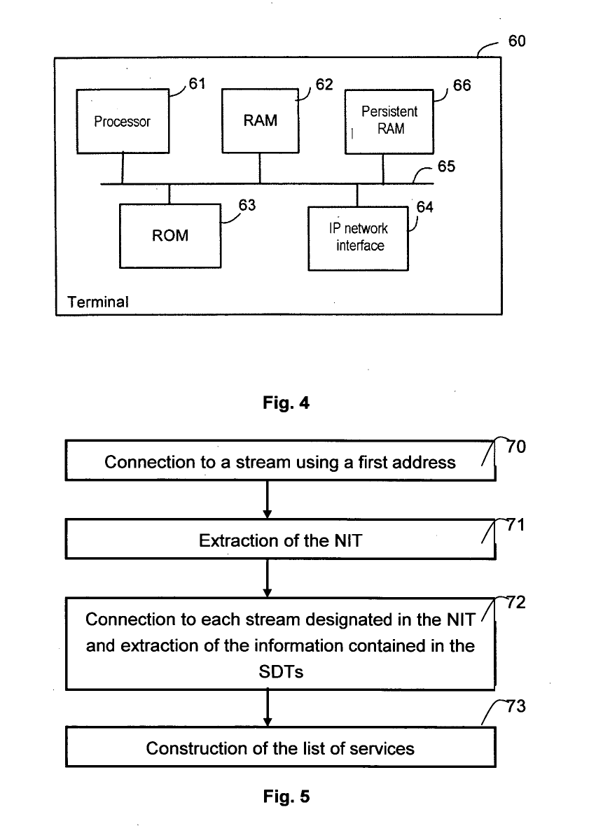

FIG. 4 represents the hardware architecture of a terminal operating according to an exemplary embodiment of the invention.

FIG. 5 represents a diagram of the various steps of the method.

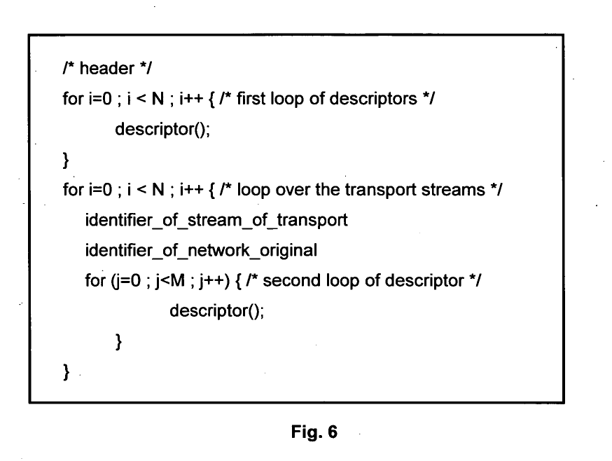

FIG. 6 represents the structure of an NIT (Network Information Table) according to the DVB standard.

The connection to a transport stream on an IP type network may be done according to a multipoint transmission protocol (IP multicast). An example of such a protocol is the IGMP protocol (Internet Gateway Management Protocol) defined in RFC 2236. In this protocol, with a multipoint transmission server is associated a multipoint transmission address. This address has the format of an IP address, in a domain reserved for this use, but does not correspond to the IP address of a machine accessible on the network. A terminal desiring to connect to this transmission will send a request over the network containing this multipoint transmission IP address. This request will be relayed in all the network until it reaches the server in charge of this transmission which will therefore register the terminal as client of the transmission. The routers on the path between the server and the terminal will thereafter be in a position to relay the IP packets constituting the stream to the terminals subscribing to the transmission. Optimization of this protocol makes it possible, by knowing the IP address of the server machine in addition to the IP multipoint transmission address, to optimize the route of the subscription request by forwarding it directly to the destination server instead of transmitting it in the whole network. This optimization is known by the name SSM (Source Specific Multicast).

The connection to the transport stream may also be done according to a uniport transmission protocol (IP unicast). An example of such a protocol is the RTSP protocol (Real Time Streaming Protocol) defined in RFC 2326. This protocol serving to control the transmission of the stream over IP, it is designed to operate jointly with a transmission protocol proper such as RTP. The principal difference with multipoint transmission being that at each client desiring to connect up to the stream, the server will initiate a point-to-point transmission between itself and the client. It is obvious that this solution is more extravagant in terms of bandwidth than the solution based on multipoint transmission, but it is conceivable within the framework of a restricted network where only a small number of terminals are able to connect to a stream.

FIG. 1 describes the general architecture of a production chain for DVB MPEG-2 services within the framework of a satellite transmission. At the start of the chain, we have audio and video content 1 that is to be transmitted. This content is encoded according to the MPEG2 standard in a coder 2 so as to generate an audio/video elementary stream 5. In parallel with the coding of the audio and of the video, the signalling information 3 is generated, it generally originates from a database containing the descriptive information about the service that one wishes to transmit. This information is generated in the form of a signalling stream 6. Another module 4 takes charge of the generation of a subtitles stream 7. It is also possible to include an interactive applications stream 8, the production chain of which is not detailed here. All these elementary streams, possibly with other streams conveying other audio and video contents, the signalling pertaining thereto or otherwise, are thereafter multiplexed in a multiplexer 9 to generate the MPEG-2 transport stream which will thereafter be modulated and converted onto a frequency chosen by the converter modulator 10. A set of streams of this type may be mixed by a mixer 11 for dispatch to a satellite 13 via a sending station 12. In this case a synchronization of the signalling information is necessary between the various streams so as to include information about the other streams in the descriptive tables of each stream. These programs may thereafter be received at the user's home via his dish 14 so as to be decoded by a decoder and displayed on a television. This chain is now well perfected by operators.

FIG. 2 represents the architecture of a transport stream containing just one service and all the signalling tables attaching thereto. The bandwidth and the architecture of an IP network make it more practical to separate each service into its own stream. Specifically, in contradistinction to the case of the satellite whose stream is intended for multiple terminals that can select any one of the services available, in an IP network each terminal can connect up to the stream containing the desired service and it alone. However, it is obvious that the use of a stream containing several services is possible. A first stream 41 contains an SDT (Service Description Table) 43 which describes the service or services available in the stream. The service 42 contains a PMT (Program Map Table) 46 as well as the elementary streams of the service, video 47, audio 48 or other 49. The stream also contains a PAT (Program Allocation Table) 44 pointing among other things to the NIT 45. The NIT gives information about the physical organization of the various transport streams 50, 51, 52 offered by the network. The NIT is organized as indicated in FIG. 6.

This structure of the NIT remains suitable for the description of a network over IP except that it is necessary to define descriptors specific to the IP network so as to take account of the broadband transmission over IP system. We give below the definition of an example of such a descriptor suitable for multipoint transmission:

| Name of the field | Number of bits | Identifier |
|---|---|---|
| Descriptor_tag | 8 | uimsbf |
| Descriptor_length | 8 | uimsbf |
| IP_multicast_address | 32 | bslbf |
| Multicast_Port_number | 16 | bslbf |
| Multicast_protocol_mapping | 8 | bslbf |
| IP_source_address | 32 | bslbf |

The “descriptor_tag” field is an identifier corresponding to this new type of descriptor.

The “descriptor_length” gives the size of the descriptor.

The “IP_multicast_address” field is the IP multipoint transmission address of the server on which the stream is available.

The “Multicast_Port_number” field is the port number on the server where one has to connect to receive the stream.

The “Multicast_protocol_mapping” field is a field identifying the protocol for coding the service or services transmitted to this address, this may be MPEG-2, MPEG-4, MHP or others. This field, optional, can make it possible to filter with regard to the type of content so as to retain only the services that the terminal is in a position to decode.

The “IP_source_address” field is the actual IP address of the server, thereby allowing effective routing of the request for connection to a multipoint transmission server according to the SSM protocol.

We give below the definition of another example of such a descriptor suitable for unipoint transmission:

| Name of the field | Number of bits | Identifier |
|---|---|---|
| Descriptor_tag | 8 | uimsbf |
| Descriptor_length | 8 | uimsbf |
| IP_unicast_address | 32 | bslbf |
| Unicast_Port_number | 16 | bslbf |
| Unicast_protocol_mapping | 8 | bslbf |

The “descriptor_tag” field is an identifier corresponding to this new type of descriptor.

The “descriptor_length” gives the size of the descriptor.

The “IP_unicast_address” field is the IP unipoint transmission address of the server on which the stream is available.

The “Unicast_Port_number” field is the port number on the server where one has to connect to receive the stream.

The “Unicast_protocol_mapping” field is a field identifying the protocol for coding the service or services transmitted to this address, this may be MPEG-2, MPEG-4, MHP or others. This field, optional, can make it possible to filter with regard to the type of content so as to retain only the services that the terminal is in a position to decode.

These descriptors signal a multipoint or unipoint transmission server containing a transport stream with usually a DVB television service. We see in the structure of the NIT that their exists a loop over the transport streams, which implies that all the transport streams constituting the complete network of an operator can be described in this loop. In this way, the terminal can construct a list with the multipoint or unipoint transmission IP addresses of all the transport streams of a broadband over IP television transmission network. A list of service descriptors may optionally be included in the NIT so as to accelerate the phase of installation of the terminal.

It is also conceivable for multipoint and unipoint stream servers to be present in the same network.

FIG. 3 represents a diagram of the architecture of the production chain modified according to an exemplary embodiment of the invention. We again find the same start of chain as in FIG. 1 in the conventional case of transmission by modulation of satellite, cable or terrestrial type. The differences are to be found at the level of the generation of the signalling information 3. We have to adapt the NIT to operation on the IP network as explained earlier, that is to say including therein IP broadband transmission services descriptors. The stream thus constructed is placed on a stream server 30 allowing transmission thereof over the IP network. All the streams making up the network of the operator are thus made available to the terminal 33 connected to its IP network 32, this being symbolized in the diagram by their hookup behind the router 31. In practice these stream servers may be made available to a user connected, for example via an ADSL accessway (Asymmetric Digital Subscriber Line), making them accessible on the Internet. However, this solution has the drawback that one is not master of the over-Internet bandwidth between the server and the access point linking the user. Another solution is to connect these servers via a network making it possible to manage the quality of service, such as an ATM network (Asynchronous Transfert Mode), to the access points of the users.

FIG. 4 represents the internal architecture of a terminal 60 which possesses read only memory (ROM 63) allowing it to store programs and data, random access memory (RAM 62) which allows it to load these programs with a view to execution by the processor 61. This processor can also use persistent RAM to store information like the database. This terminal is connected to an IP type network by a network interface 64. These components communicate by way of an internal bus 65.

The phase of discovery of the services on an IP broadband network by a terminal runs as follows. The terminal possesses a broadband connection to an IP network, this connection may be a connection to Internet according to the ADSL technique or cable based. This connection can also be made on a private network, such as a company network or a domestic network. The terminal possesses parameters allowing it a first connection to an IP multipoint or unipoint transmission address. The simplest solution is to consider that this IP transmission address is input manually into a configuration menu. This IP transmission address can also be allocated to the terminal during the phase of connection via protocols such as DHCP (Dynamic Host Control Protocol) or PPP (Point to Point Protocol). However, any other method of determining this first IP address is possible. This address consists of a multipoint or unipoint IP transmission address and a corresponding port number.

The steps of the method are represented in FIG. 5.

In a first step 70, the terminal connects to this IP address on the given port and activates, for example via the IGMP protocol, the reception of the transport stream which is available there. Generally this transport stream is of the MPEG-2 type encapsulated over IP using the IP/UDP/RTP protocol layers (User Datagram Protocol, Real Time Protocol), but it may also be an MPEG4, MHP or other type stream.

The transport stream is extracted from the RTP packets. This stream contains the PAT, PMT, NIT and SDT tables. The tables contained in the stream are exactly the tables as specified in the DVB-SI standard, with the exception of the network descriptors as defined above situated in the NIT.

In a second step 71, the terminal extracts the NIT contained in the stream and analyses it to construct the list of IP transmission addresses and associated ports making it possible to receive the streams available over the network.

In a third step 72, the terminal connects successively to at least part of these transport streams available over the network. The terminal will extract from these streams the description information for the services contained in the SDT. According to an alternative, this information is read directly via a set of service descriptors included in the NIT. In this case it is not necessary to connect up to the various streams available over the network.

In a fourth step 73, the terminal constructs the database containing the list of all the services offered on the network and makes it available to the user via, for example, an electronic program guide. The database can, for example, be stored in the persistent RAM of the terminal so as to be easily accessible when the terminal is booted without it being necessary to repeat this process.

The terminal can use the information contained in this base to respond to a query from the user wishing to connect up to one of the services on offer. The terminal finds in the base the IP address and the port number of the stream server transmitting the desired service, it can therefore connect up to the stream in question and fetch therefrom the stream containing the service so as to display it.

The invention allows operators to reuse the major part of their existing production chain, in particular the multiplexers and their equipment for producing the signalling information. The information also makes it possible to limit the modifications to be made to the software executed on the decoders. Specifically, only the part managing the IP interface, instead of the satellite or cable reception interface, is new. The whole of the part for analysing the stream and managing the signalling information can be borrowed from the software used on the satellite or cable decoders. Likewise, access control can be borrowed identically. The invention therefore allows the adoption of the transmitting of DVB services over a broadband IP network while minimizing the investment and risks for the operators.

1. Method of discovery, by a terminal connected to an Internet Protocol (IP) type network, of (Digital Video Broadcast (DVB) services on the IP type network, wherein it comprises at least the following steps:
the terminal uses a first IP transmission address and a first port number to receive a transport stream transmitted to this IP address on this port;
the terminal extracts from the said stream at least the networks information table (NIT)
the descriptors of networks contained in the said networks information table designating IP transmission addresses and the associated ports, the terminal connects to at least part of the transport streams transmitted to the said IP addresses on the said ports so as to read the associated service description table (SDT);
the terminal uses this information to construct a possibly unitary list of the services available on the network.

2. Method according to claim 1 where the first IP transmission address and the first port number are entered by the user.

3. Method according to claim 1 where the first IP address and the first port number are obtained from the network by the terminal.

4. Method according to claim 1 where the streams contain only a single DVB service.

5. Method according to claim 1 where the list of services is included in the NIT contained in the stream available at the first IP transmission address on the first port.

6. Device possessing means to connect to an Internet Protocol (IP) transmission address via means of connection to an IP network and means of decoding of Digital Video Broadcast (DVB) streams transmitted to this IP transmission address, wherein the means of decoding of DVB streams have the capacity to analyse an networks information table (NIT), extracted from the stream, containing network descriptors suitable for the IP network and to connect to each IP transmission address described in the said NIT so as to read therefrom a DVB stream and extract therefrom the information on the services offered on the network.

7. Descriptor of a service for transmitting a Digital Video Broadcast (DVB) stream intended to be included in an network information table (NIT) wherein it contains the Internet Protocol (IP) transmission address of a stream server and a port number on which the said server transmits a DVB stream over an IP type network.
